(19) United States
(12) Patent Application Publication
(10) Pub. No.: US 2026/0238970 A1
(43) Pub. Date: Aug. 13, 2026

(54) INTEGRATION OF COMMUNICATION AND SENSING TO DETECT DEVICE ABNORMALITY

(71) Applicant: Apple Inc., Cupertino, CA (US)

(72) Inventors: Yingluo LUO, Beijing (CN); Dawei ZHANG, Saratoga, CA (US); Haijing HU, Los Gatos, CA (US); Huarui LIANG, Beijing (CN); Mona AGNEL, Guildford, Surrey (GB); Shu GUO, Beijing (CN); Xiaoyu QIAO, Beijing (CN); Yuqin CHEN, Beijing (CN)

(21) Appl. No.: 19/154,220

(22) PCT Filed: Feb. 10, 2023
(86) PCT No.: PCT/CN2023/075319

§ 371 Date: Aug. 6, 2025

(51) Int. Cl. H04W 4/46; H04W 4/90

(52) U.S. Cl. CPC H04W 4/46; H04W 4/90

(57) ABSTRACT

A method is provided. The method includes receiving, from a base station, a message that indicates a status of a user equipment (UE), where the message includes a basic safety message (BSM) transmitted in a device-to-device communication. The method includes determining, based on the message, to perform sensing with the UE. The method includes transmitting, to the base station, a request to perform sensing with the UE. The method includes receiving, from the base station, a sensing result. The method includes generating a UE status report based on the sensing result and the message. Also provided are a network server and a base station.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation (5G) New Radio (NR). The wireless communication networks facilitate mobile broadband service using technologies such as OFDM, multiple input multiple output (MIMO), advanced channel coding, massive MIMO, beamforming, and/or other features.

A wireless user device, such as a user equipment (UE), may use a wireless communication network to communicate with an access node, such as a base station. Such communication is often referred to as cellular communication. The wireless user device may also use the wireless communication network to communicate with other devices. Such communication is often referred to as device-to-device communication. One example of device-to-device communication is vehicle-to-vehicle (V2V) communication. In V2V communication, UEs associated with different vehicles communicate with each other to exchange information.

### SUMMARY

In accordance with one aspect of the present disclosure, a method is provided. The method includes receiving, from a base station, a message that indicates a status of a user equipment (UE), the message including a basic safety message (BSM) transmitted in a device-to-device communication. The method includes determining, based on the message, to perform sensing with the UE. The method includes transmitting, to the base station, a request to perform sensing with the UE. The method includes receiving, from the base station, a sensing result. The method includes generating a UE status report based on the sensing result and the message.

In some implementations, the method further includes determining, based on the UE status report, an abnormality from the message. The method further includes transmitting an alert to the base station. The alert causes the base station to transmit a warning about the abnormality to one or more nearby UEs.

In some implementations, the alert includes at least one of: an identifier of the UE; a type of the abnormality; or a suggestion of one or more actions to be taken by the one or more nearby UEs.

In some implementations, the alert causes the base station to transmit a control message to the UE.

In some implementations, the method further includes receiving, from the base station, an acknowledgement to the request.

In some implementations, the message includes a non-access stratum (NAS) container, and the NAS container includes the BSM. The device-to-device communication is a vehicle-to-vehicle (V2V) communication from the UE to one or more nearby UEs.

In some implementations, the request includes at least one of: a time of the sensing; a type of the sensing; a session identifier of the sensing; or one or more sensing parameters.

In some implementations, the sensing result includes at least one of: a distance from the UE to the base station; a direction of movement of the UE; or an orientation of the UE.

In some implementations, generating the UE status report includes: comparing the sensing result with the message; determining a mismatch between the sensing result and the message; and determining an abnormality based on the mismatch.

In some implementations, the sensing result is received in one or more packet data units (PDUs) via the user plane.

In accordance with another aspect of the present disclosure, a network server is provided. The network server has a sensing function (SF) entity and an application function (AF) entity. The SF entity receives, from a base station, a message that indicates a status of a UE. The SF entity determines, based on an analysis of the message, to perform sensing with the UE. The SF entity transmits, to the base station, a request to perform sensing with the UE. The SF entity receives, from the base station, a sensing result. The SF entity generates a UE status report based on the sensing result and the message. The SF entity transmits the UE status report to the AF entity.

In some implementations, the SF entity obtains the analysis of the message by: extracting data from the message, and obtaining UE information from the data.

In some implementations, the SF entity forwards the message to the AF entity. The AF entity extracts data from the message, obtains UE information from the data, and analyzes the UE information. The SF entity obtains the analysis from the SF entity.

In some implementations, the SF entity determines, based on the UE status report, an abnormality from the message. The SF entity transmits an alert to the base station, wherein the alert causes the base station to transmit a warning about the abnormality to one or more nearby UEs

In some implementations, to generate the UE status report, the SF entity compares the sensing result with the message, determines a mismatch between the sensing result and the message, and determines an abnormality based on the mismatch.

In accordance with yet another aspect of the present disclosure, a base station is provided. The base station has a processor configured to execute instructions, stored in a memory, that cause the base station to perform operations. The operations include receiving a message that indicates a status of a UE, the message including a BSM transmitted in a device-to-device communication. The operations include transmitting the message to a network entity. The operations include receiving, from the network entity, a request to perform sensing with the UE. The operations include performing the sensing according to the request. The operations include transmitting a sensing result to the network entity.

In some implementations, the operations further include determining an availability of resources after receiving the request. The operations further include transmitting an acknowledgement to the request to the network entity based on the availability.

In some implementations, the operations further include receiving an alert from the network entity. The operations further include, in response to the alert, transmitting at least one of (i) a control message to the UE, or (ii) a warning about the abnormality to one or more nearby UEs.

In some implementations, the base station receives the message from the UE via a Uu interface.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system, according to some implementations.

FIG. 2 illustrates a block diagram showing communication involving an example network server, according to some implementations.

FIGS. 3A and 3B each illustrate a flowchart of an example method, according to some implementations.

FIGS. 4A and 4B each illustrate a flowchart showing example interactions between components of a wireless network, according to some implementations.

FIG. 5 illustrates an example UE, according to some implementations.

FIG. 6 illustrates an example access node, according to some implementations.

### DETAILED DESCRIPTION

In device-to-device communication, a device may rely on information obtained from other devices to make operation decisions. For example, in V2V communication, a vehicle may be equipped with a UE to receive information about the status of other vehicles, such as the location, speed, acceleration, and/or orientation of other vehicles. The vehicle may use the received information to make decision about its own driving behavior. In some V2V communication, UEs from different vehicles utilize a wireless network, such as a RAN, to exchange status information using messages, such as basic safety messages (BSMs).

With the growing number of vehicles having self-driving capability, the accuracy and reliability of vehicle status information has become increasingly important to road safety. However, existing techniques may be insufficient to detect abnormalities (e.g., errors) from the content of BSMs.

This disclosure describes methods and systems that provide solutions to these challenges. As described in detail below, implementations of this disclosure provide a mechanism that verifies the content of a BSM using sensing results. In particular, implementations of this disclosure enable a network server to utilize a RAN to obtain sensing results from a particular UE, and to compare the sensing results with the BSM content received via cellular communication. The network server can thus detect abnormalities in the BSM and alert UEs that are near the particular UE (“nearby UEs”). Based on the alert, the nearby UEs can avoid relying on the abnormal BSM to make incorrect driving decisions, and pedestrians near the particular UE can exercise caution with regard to nearby safety hazards. As such, implementations of this disclosure can improve road safety. Additionally, because obtaining and transmitting sensing results consume little cellular communication resource of the RAN, the mechanism provided by the implementations does not noticeably increase the load of the RAN. Furthermore, because the network server can receive both the BSM and the sensing results from the same RAN, implementations of this disclosure effectively integrate sensing with cellular communication without significantly increasing system complexity.

The description below assumes that the UEs communicate in V2V communication. However, this disclosure contemplates other types of device-to-device communication. For example, the UEs can be associated with other transportation means, such as bicycles, scooters, drones, airplanes, vessels, or robots. In addition, besides information relating to the physical movement of a device, the device status information (e.g., the content of BSMs) can include any type of information relating to the safe and orderly operation of the devices.

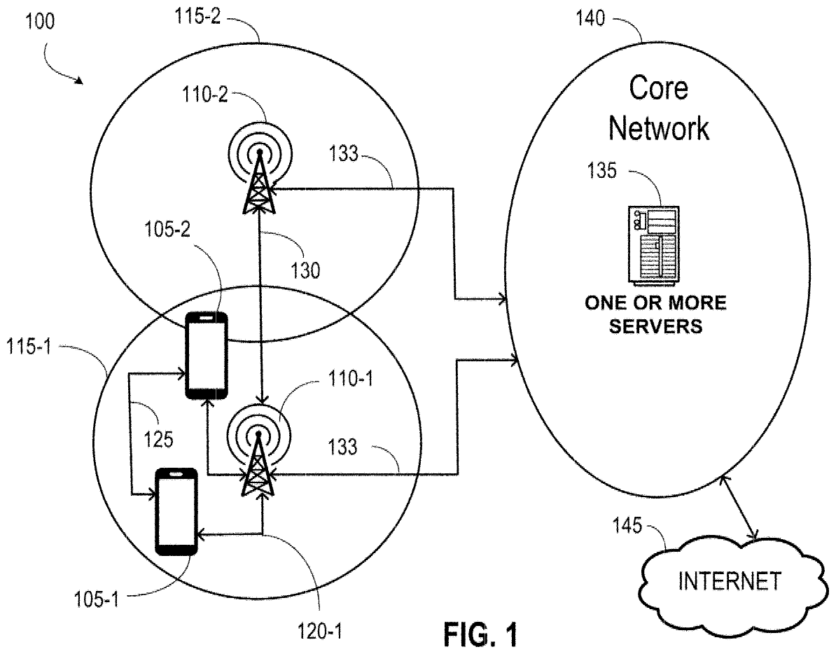

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)), IEEE 802.16 protocols, or the like. While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V 2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and road side units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more network servers 135 within the CN 140 over another backhaul connection 133. The backhaul connections can be wired and/or wireless connections. The one or more network servers 135 may include one or more network entities configured to perform certain network functions. The network functions can be configured to provide services of a core network, such as a 5th Generation Core network (5GC).

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

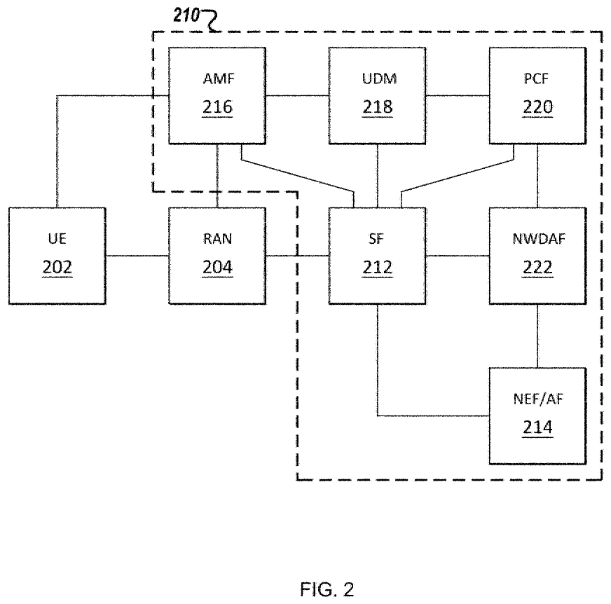

FIG. 2 illustrates a block diagram 200 showing communication involving an example network server 210, according to some implementations. Network server 210 can provide, e.g., 5GC service to UE 202 via RAN 204. In block diagram 200, UE 202 can be similar to UEs 105 of FIG. 1, and RAN 204 can be managed by a base station that is similar to base station 110-1 of FIG. 1. In the description below, the term “RAN 204” refers to the base station that manages the wireless network serving UE 202.

Network server 210 can support cellular communication between UE 202 and RAN 204. Utilizing the cellular service, UE 202 can transmit a BSM to RAN 204 via, e.g., a Uu interface. UE 202 can also broadcast the same BSM to nearby UEs via, e.g., a PC5 interface. Using the BSM, UE 202 can provide information about the status of an associated vehicle to nearby UEs and/or to RAN 204 and to network server 210. For example, UE 202 can provide in the BSM the three-dimensional (3D) position information of the vehicle, such as coordinates (x, y, z) representing the latitude, the longitude, and the elevation of the vehicle.

Network server 210 can also request RAN 204 to perform sensing with UE 202. RAN 204 can perform sensing using hardware (e.g., transceivers of sensing signals) of its own, or can control roadside infrastructure hardware (e.g., surveillance cameras) to perform the sensing. Network server 210 can obtain the 3D position of the sensing hardware from RAN 204.

Network server 210 has a plurality of network entities configured to perform network functions. In some implementations, the network entities are implemented on separate hardware circuits and/or computers. In some alternative implementations, some or all of the network entities can be integrated on the same circuit and/or computer. In some alternative implementations, the network entities can be virtually implemented as software code.

The network entities may be referred to according to their corresponding network functions. In the example of block diagram 200, the network entities include: access and mobility management function (AMF) 216, unified data management (UDM) 218, policy control function (PCF) 220, sensing function (SF) 212, network data analytics function (NWDAF) 222, and network exposure 11 function or application function (NEF/AF) 214. Other network servers may have fewer or more network entities. The description below primarily focuses on SF 212 and AF 214.

SF 212 can initiate a sensing session when SF 212 determines there is a likelihood that the BSM contains inaccurate information. For example, SF 212 can determine that the BSM likely contains inaccurate information if the BSM indicates that the vehicle's position is not suitable for driving, such as in a water area. As another example, SF 212 can determine that the BSM likely contains inaccurate information if two consecutive BSMs from the vehicle indicate that the vehicle's position has changed extraordinarily large within a short period, such as a kilometer within 100 milliseconds.

To initiate a sensing session, SF 212 can request RAN 204 to perform sensing with UE 202 to verify the accuracy of the BSM. In the request, SF 212 can specify one or more attributes of the sensing session. The attributes can include a timing of the sensing, such as when to perform the sensing and how many times to perform the sensing. Additionally or alternatively, the attributes can include a type of the sensing, e.g., whether RAN 204 should perform the sensing using a millimeter-wave transceiver, a laser transceiver, or a camera. Further, the attributes can include an identifier (ID) of the sensing, e.g., an ID of the sensing session, an ID of the UE, or an ID of the sensing hardware. These attributes can also include configuration parameters of the sensing, e.g., timing of the sensing session, settings of the sensing hardware, frequency band of the sensing signals, or orientation of sensing signal emission.

SF 212 can receive and process the information gathered during a sensing session. For example, SF 212 can receive a sensing result from RAN 204, extract information about the status of UE 202, and analyze the extracted information. The information can indicate, e.g., a distance from UE 202 and the sensing hardware, a direction of movement of UE 212 (or its associated vehicle), an orientation of UE 212 (or its associated vehicle). SF 212 can compare (a) the information extracted from the sensing result with (b) the information provided in the BSM. Based on the comparison, SF 212 can determine whether (a) and (b) sufficiently correlate to each other and/or whether (a) and (b) are inconsistent. An inconsistency between (a) and (b) may indicate an abnormality of the BSM. In scenarios where SF 212 requested RAN 204 to perform sensing multiple times, SF 212 can analyze the extracted information using one or more statistical approaches, such as averaging. Alternatively or additionally, in scenarios where SF 212 requested RAN 204 to perform sensing within a time window, SF 212 can consider the sensing result to be 0 (or similarly null, void, N/A, etc.) if SF 212 does not receive the sensing result within the time window.

For example, SF 212 can obtain a distance d2 between UE 202 and the sensing hardware from the sensing result. SF 212 can also obtain, from a BSM transmitted by UE 202, the 3D position information of the associated vehicle. SF 212 can further calculate a distance d1 between the position of the vehicle and the position of the sensing hardware (known to network server 210). If d2>0 and the difference between d2 and d1 is within a predefined threshold, SF 212 can determine that the sensing result is consistent with the BSM. If d2 differs from d1 by an amount greater than a predefined threshold, SF 212 can determine that the sensing result mismatches the BSM. If d2=0, SF 212 can determine that the sensing hardware was unable to timely locate the vehicle identified by UE 202. In this case, SF 212 can determine that the BSM has incorrect values in a “heading” field or similar fields.

Alternative or in addition to SF 212 analyzing the sensing result, SF 212 can forward the received sensing result to AF 214 for analysis. AF 214 can inform SF 212 of the outcome of the analysis.

After processing the sensing result and/or receiving the analysis outcome from AF 214, SF 212 can generate a report that describes the status of UE 202. In the report, SF 212 can identify UE 202 by providing, e.g., an identification number of the associated vehicle and/or a pseudo certificate that uniquely identifies UE 202. In the report, SF 212 can also identify RAN 204 and provide parameters used by RAN 204 to receive the BSM and/or perform the sensing. SF 212 can also describe any abnormality in the BSM determined based on the sensing result. For example, SF 212 can describe the type of the abnormality, such as incorrect 3D position information or incorrect heading. Furthermore, SF 212 can include within the report one or more recommended actions for mitigating the safety risk due to the abnormality. Example recommended actions include: recording the vehicle information in a registry, issuing a warning to the vehicle owner or operator, notifying road safety regulators, notifying vehicle manufacturers or repair facilities, triggering emergency protocols in the network, or suspending network service to UE 202.

After determining an abnormality, SF 212 can transmit, via RAN 204, an alert to one or more nearby UEs. In the alert, SF 212 can identify UE 202, and/or describe the type of the abnormality. SF 212 can also suggest the nearby UEs exercise caution when making transportation decisions by, e.g., disregarding the BSMs broadcast by UE 202 and/or increasing the distance from the vehicle associated with UE 202. The alert can be formatted, e.g., within one or more system information blocks (SIBs). In some implementations, RAN 204 broadcasts the alert without specifying which nearby UEs are the intended recipients of the alert.

After detecting an abnormality, SF 212 can also transmit, via RAN 204, a control message to UE 202. The control message can instruct UE 202 to, e.g., stop broadcasting BSMs, instruct the associated vehicle to perform an emergency stop, execute a self-checking procedure, or notify a human operator or passenger. SF 212 can transmit the control message at SF 212's own discretion or following an instruction from AF 214. The control message can also be formatted, e.g., within one or more SIBs.

AF 214 works with SF 212 to perform the sensing and detect the abnormality in the BSM. For example, AF 214 can provide criteria that SF 212 uses to determine a suspicious BSM before initiating a sensing session. AF 214 can provide SF 212 with software and/or hardware configurations used in the sensing process. AF 214 can also receive the report generated by SF 212 and determine mitigation actions in view of the abnormal BSM. In implementations where SF 212 processes the sensing result, AF 214 can provide SF 212 with information for determining BSM abnormality, such as the maximum allowed difference between d2 and d1.

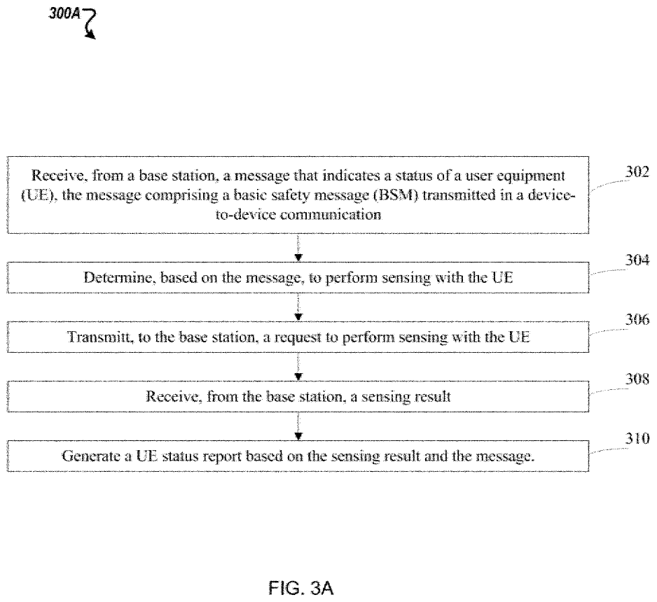

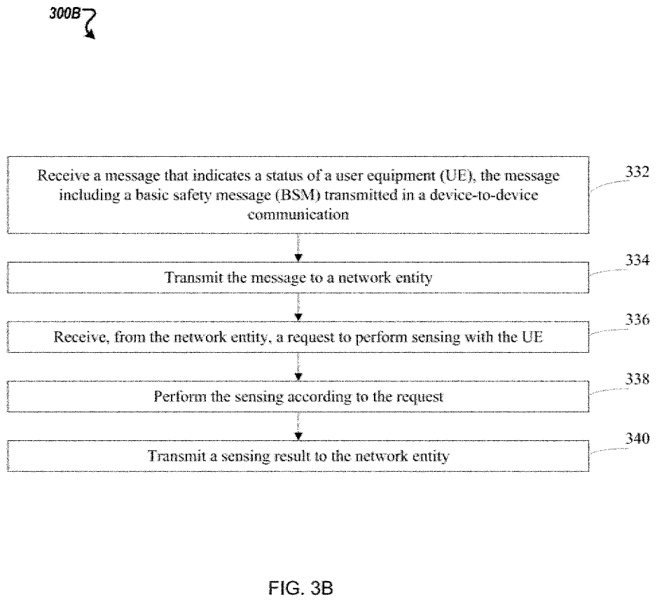

FIG. 3A illustrates a flowchart of an example method 300A, according to some implementations. For clarity of presentation, the description that follows generally describes method 300A in the context of the other figures in this description. For example, method 300A can be performed by network server 210 of FIG. 2. It will be understood that method 300A can be performed, for example, by any suitable system, environment, software, hardware, or a combination of systems, environments, software, and hardware, as appropriate. In some implementations, various steps of method 300A can be run in parallel, in combination, in loops, or in any order.

At 302, method 300A involves receiving, from a base station, a message that indicates a status of a UE, the message including a BSM transmitted in a device-to-device communication. The base station can be similar to RAN 204 of FIG. 2, and the UE can be similar to UE 202 of FIG. 2. The device-to-device communication can be, e.g., a V2V communication. In some implementations, the message can include an NAS container that contains the BSM.

At 304, method 300A involves determining, based on the message, to perform sensing with the UE. The determination can be based on a suspicion that the BSM contains inaccurate information, as described earlier with reference to FIG. 2.

At 306, method 300A involves transmitting, to the base station, a request to perform sensing with the UE. The request can include one or more attributes of the sensing session, a type of the sensing, and ID of the sensing, or configuration parameters of the sensing, as described earlier with reference to FIG. 2.

At 308, method 300A involves receiving, from the base station, a sensing result. The sensing result can indicate, e.g., a distance between the UE and the sensing hardware, as described earlier with reference to FIG. 2. In some implementations, the sensing result is received via a user plane or via a control plane. For example, the sensing result can be received in one or more PDUs via the user plane.

At 310, method 300A involves generating a UE status report based on the sensing result and the message. Similar to the description with reference to FIG. 2, the UE status report can identify the UE and/or the base station, describe any detected abnormality, or provide recommended actions for mitigating the safety risk due to the abnormality.

FIG. 3B illustrates a flowchart of an example method 300B, according to some implementations. For clarity of presentation, the description that follows generally describes method 300B in the context of the other figures in this description. For example, method 300B can be performed by RAN 204 of FIG. 2. It will be understood that method 300B can be performed, for example, by any suitable system, environment, software, hardware, or a combination of systems, environments, software, and hardware, as appropriate. In some implementations, various steps of method 300B can be run in parallel, in combination, in loops, or in any order.

At 332, method 300A involves receiving a message that indicates a status of a UE, the message including a BSM transmitted in a device-to-device communication. The UE can be similar to UE 202 of FIG. 2. The device-to-device communication can be, e.g., a V2V communication. In some implementations, the message can include an NAS container (or other types of data structure) that contains the BSM.

At 334, method 300A involves transmitting the message to a network entity. The network entity can be similar to network server 210 of FIG. 2. In some implementations, the message is forwarded to the network entity as a whole. In some implementations, the message is transmitted to the network entity after certain modification, such as removal of an NAS container.

At 336, method 300A involves receiving, from the network entity, a request to perform sensing with the UE. The request can be similar to the request transmitted at 306 of FIG. 3A.

At 338, method 300A involves performing the sensing according to the request. The performance of the sensing can follow one or more settings that are specified in the request.

At 340, method 300A involves transmitting a sensing result to the network entity. The sensing result can be similar to the sensing result that the base station receives at 308 of FIG. 3A.

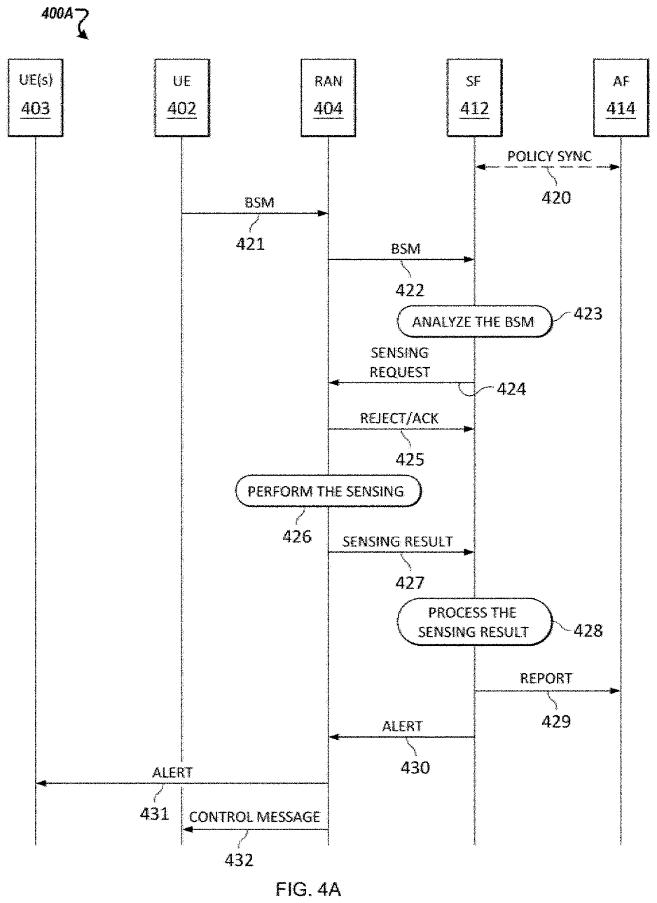

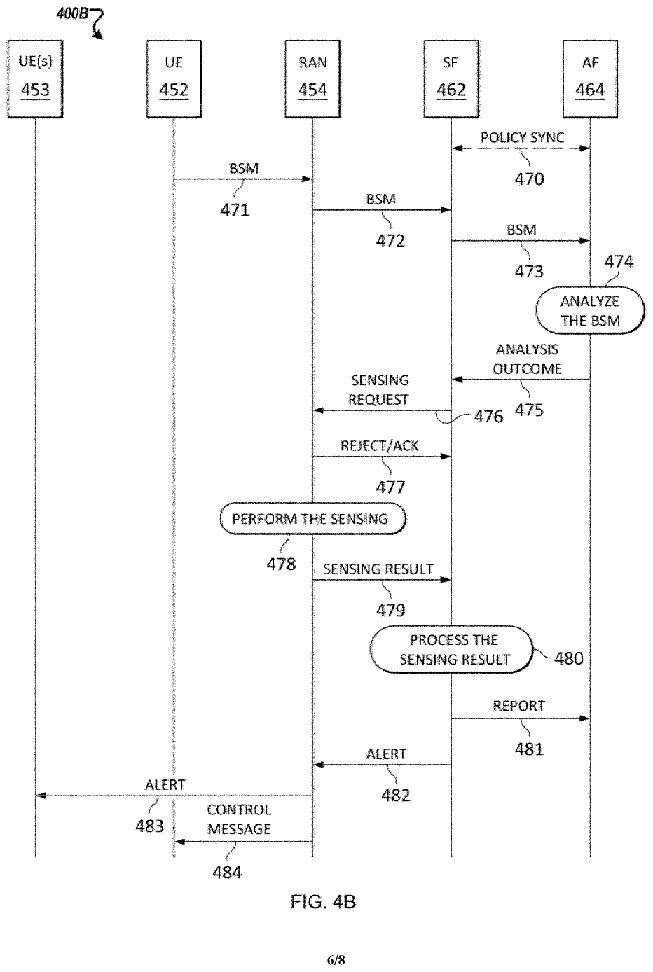

FIGS. 4A and 4B each illustrate a flowchart showing example interactions 400A and 400B between components of a wireless network, according to some implementations. Some interactions in FIGS. 4A and 4B are similar to one or more operations described above with reference to FIGS. 2, 3A and 3B.

Beginning with FIG. 4A, interactions 400A involve UE 402 and RAN 404, which may be similar to UE 202 and RAN 204, respectively, of FIG. 2. Interactions 400A also involve SF 412 and AF 414, which may be similar to SF 212 and AF 214, respectively, of FIG. 2. Interactions 400A further involve one or more UEs 403, which may be nearby UEs of UE 402.

At 420, SF 412 and AF 414 perform policy synchronization in preparation for processing BSMs. The policy synchronization can include, e.g., exchange of information of communication protocol between SF 412 and 414, agreeing on whether SF 412 or AF 414 analyzes received BSMs, sharing information for decoding BSMs, sharing criteria for determining suspicious and/or abnormal BSMs, determining the time window for sensing, or determining the sensing hardware and related parameters. In some implementations where SF 412 and AF 414 are already in-sync, policy synchronization at 420 may be skipped.

At 421, RAN 404 receives a BSM from UE 402. The reception of the BSM at 421 can be similar to the operation at 332 of FIG. 3B.

At 422, RAN 404 transmits the BSM to SF 412. The transmission of the BSM at 422 can be similar to the operation at 302 of FIG. 3A or the operation at 334 of FIG. 3B.

At 423, SF 412 analyzes the BSM. Similar to the operation at 304 of FIG. 3A, SF 412 can use the analysis as a basis for determining whether to perform sensing with UE 402.

At 424, SF 412 sends a sensing request to RAN 404 to initiate a sensing session with UE 402. The sending of the sensing request can be similar to the operation at 306 of FIG. 3A or the operation at 336 of FIG. 3B.

At 425, RAN 404 accepts the sensing request by sending an acknowledgement to SF 412, or rejects the sensing request by sending a rejection to SF 412. RAN 404 can determine whether to accept the sensing request based on a number of factors, such as the capability of RAN 404 and/or UE 402, the availability of communication resource at RAN 404, the availability of sensing hardware that RAN 404 can use, or the status (e.g., in-network or roaming) of UE 402. In some implementations, RAN 404 uses a Boolean variable to indicate acknowledgement or rejection. For example, RAN 404 can transmit a value of “1” to indicate rejection and transmits a value of “0” to indicate acknowledgement. Besides the acknowledgement/rejection, RAN 404 can indicate the reason for a rejection. For example, RAN 404 can use a failure code “11” to indicate that RAN 404 is overloaded and does not have capacity to perform the requested sensing.

At 426, assuming RAN 404 accepts the sensing request, RAN 404 performs the sensing either by using hardware of its own or by directing sensing hardware that is physically remote to RAN 404. The performance of the sensing can be similar to the operation at 338 of FIG. 3B.

At 427, RAN 404 transmits the sensing result to SF 412. The transmission of the sensing result can be similar to the operation at 308 of FIG. 3A or the operation at 340 of FIG. 3B. As described previously with reference to FIG. 2, in the event RAN 404 does not timely obtain the sensing result, RAN 404 can transmit a default value of 0 (or similarly void, null, N/A, etc.) as the sensing result.

At 428, SF 412 processes the sensing result. The process of the sensing result can be similar to the analysis of the sensing result described previously with reference to FIG. 2.

At 429, SF 412 generates and transmits a report to AF 414. The generation of the report can be similar to the operation at 310 of FIG. 3A.

At 430 and 431, SF 412 transmits an alert to RAN 404, which forwards the alert to UE(s) 403. Similar to the operations described with reference to FIG. 2, in the alert, SF 412 can identify UE 202, describe the type of the abnormality, and/or suggest UE(s) 403 to exercise caution.

At 432, RAN 404 transmits a control message to UE 402 in response to the alert. Similar to the operations described with reference to FIG. 2, in the control message, SF 412 can control UE 402 to take one or more actions in view of the abnormality in the BSM.

Turning to FIG. 4B, interactions 400B involve UE 452 and RAN 454, which can be similar to UE 202 and RAN 204, respectively, of FIG. 2. Interactions 400B also involve SF 462 and AF 464, which can be similar to SF 212 and RAN 214, respectively, of FIG. 2. Interactions 400B further involve one or more UEs 453, which can be nearby UEs of UE 452.

In interactions 400B, operations at 470-472 and 476-484 can be similar to those at 420-422 and 424-432, respectively, in interactions 400A of FIG. 4A. For brevity, the below description omits 470-472 and 476-484 and only focuses on 473-475.

At 473, instead of analyzing the BSM, SF 462 forwards the BSM to AF 464 for analysis.

At 474, AF 464 analyzes the BSM forwarded by SF 462. The analysis at 474 can be similar to the analysis performed by SF 412 at 423 of interactions 400A.

At 475, AF 464 transmits the analysis outcome to SF 462. SF 462 can use the analysis outcome from AF 464 to determine whether the BSM is suspicious and whether to perform sensing.

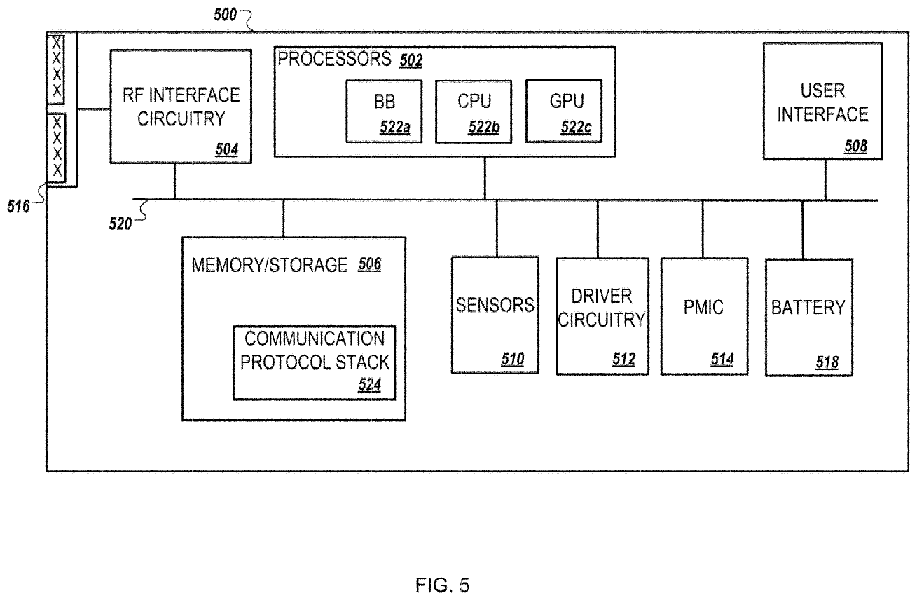

FIG. 5 illustrates an example UE 500, according to some implementations. The UE 500 may be similar to and substantially interchangeable with UEs 105 of FIG. 1.

The UE 500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, antenna structure 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516. In various implementations, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensor circuitry 528 and control and allow access to sensor circuitry 528, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

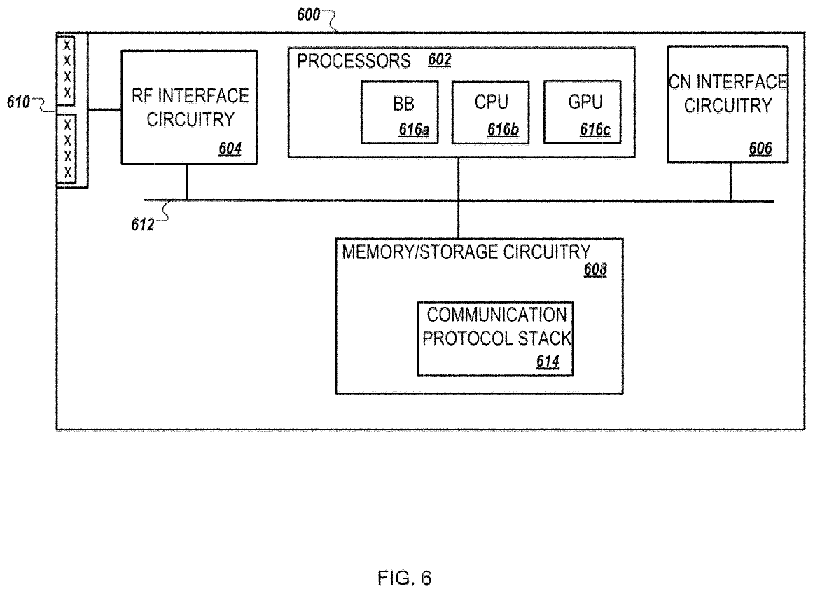

FIG. 6 illustrates an example access node 600 (e.g., a base station or gNB), according to some implementations. The access node 600 may be similar to and substantially interchangeable with base station 110-1. The access node 600 may include processors 602, RF interface circuitry 604, core network (CN) interface circuitry 606, memory/storage circuitry 608, and antenna structure 610.

The components of the access node 600 may be coupled with various other components over one or more interconnects 612. The processors 602, RF interface circuitry 604, memory/storage circuitry 608 (including communication protocol stack 614), antenna structure 610, and interconnects 612 may be similar to like-named elements shown and described with respect to FIG. 5. For example, the processors 602 may include processor circuitry such as, for example, baseband processor circuitry (BB) 616A, CPU 616B, and GPU 616C.

The CN interface circuitry 606 may provide connectivity to a core network, for example, a 5GC using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method comprising:
receiving, from a base station, a message that indicates a status of a user equipment (UE), the message comprising a basic safety message (BSM) transmitted in a device-to-device communication;
determining, based on the message, to perform sensing with the UE;
transmitting, to the base station, a request to perform sensing with the UE;
receiving, from the base station, a sensing result; and
generating a UE status report based on the sensing result and the message.

2. The method of claim 1, further comprising:
determining, based on the UE status report, an abnormality from the message; and
transmitting an alert to the base station, wherein the alert causes the base station to transmit a warning about the abnormality to one or more nearby UEs.

3. The method of claim 2, wherein the alert comprises at least one of:
an identifier of the UE;
a type of the abnormality; or
a suggestion of one or more actions to be taken by the one or more nearby UEs.

4. The method of claim 2, wherein the alert causes the base station to transmit a control message to the UE.

5. The method of claim 1, further comprising:
receiving, from the base station, an acknowledgement to the request.

6. The method of claim 1, wherein:
the message comprises a non-access stratum (NAS) container,
the NAS container comprises the BSM, and
the device-to-device communication is a vehicle-to-vehicle (V2V) communication from the UE to one or more nearby UEs.

7. The method of claim 1, wherein the request comprises at least one of:
a time of the sensing;
a type of the sensing;
a session identifier of the sensing; or
one or more sensing parameters.

8. The method of claim 1, wherein the sensing result comprises at least one of:
a distance from the UE to the base station;
a direction of movement of the UE; or
an orientation of the UE.

9. The method of claim 1, wherein generating the UE status report comprises:
comparing the sensing result with the message;
determining a mismatch between the sensing result and the message; and
determining an abnormality based on the mismatch.

10. The method of claim 1, wherein the sensing result is received via a user plane or via a control plane.

11. The method of claim 10, wherein the sensing result is received in one or more packet data units (PDUs) via the user plane.

12. A network server, comprising: a sensing function (SF) entity and an application function (AF) entity, wherein:
the SF entity receives, from a base station, a message that indicates a status of a user equipment (UE),
the SF entity determines, based on an analysis of the message, to perform sensing with the UE,
the SF entity transmits, to the base station, a request to perform sensing with the UE,
the SF entity receives, from the base station, a sensing result,
the SF entity generates a UE status report based on the sensing result and the message, and
the SF entity transmits the UE status report to the AF entity.

13. The network server of claim 12, wherein the SF entity obtains the analysis of the message by:
extracting data from the message, and
obtaining UE information from the data.

14. The network server of claim 12, wherein:
the SF entity forwards the message to the AF entity,
the AF entity extracts data from the message, obtains UE information from the data, and analyzes the UE information, and
the SF entity obtains the analysis from the SF entity.

15. The network server of claim 12, wherein:
the SF entity determines, based on the UE status report, an abnormality from the message, and
the SF entity transmits an alert to the base station, wherein the alert causes the base station to transmit a warning about the abnormality to one or more nearby UEs.

16. The network server of claim 12, wherein, to generate the UE status report, the SF entity:
compares the sensing result with the message,
determines a mismatch between the sensing result and the message, and
determines an abnormality based on the mismatch.

17. A base station, comprising a processor configured to execute instructions, stored in a memory, that cause the base station to perform operations comprising:
receiving a message that indicates a status of a user equipment (UE), the message comprising a basic safety message (BSM) transmitted in a device-to-device communication;
transmitting the message to a network entity;
receiving, from the network entity, a request to perform sensing with the UE;
performing the sensing according to the request; and
transmitting a sensing result to the network entity.

18. The base station of claim 17, the operations further comprising:
determining an availability of resources after receiving the request; and
transmitting an acknowledgement to the request to the network entity based on the availability.

19. The base station of claim 17, the operations further comprising:
receiving an alert from the network entity; and
in response to the alert, transmitting at least one of (i) a control message to the UE, or (ii) a warning about the abnormality to one or more nearby UEs.

20. The base station of claim 17, wherein the base station receives the message from the UE via a Uu interface.
